(19) United States
(12) Patent Application Publication
(10) Pub. No.: US 2019/0134820 A1
(43) Pub. Date: May 9, 2019

(54) Tank Cleaner

(71) Applicant: Oceaneering International, Inc., Houston, TX (US)

(72) Inventors: George G Holliday, JR., Zirconia, NC (US); Patrick Gustin, Lafayette, LA (US); Alex Innes, Houston, TX (US)

(73) Assignee: Oceaneering International, Inc., Houston, TX (US)

(21) Appl. No.: 16/185,811

(22) Filed: Nov. 9, 2018

Related U.S. Application Data
(60) Provisional application No. 62/583,614, filed on Nov. 9, 2017.

(51) Int. Cl. B25J 9/16; B25J 11/00

(52) U.S. Cl. CPC B25J 9/1697; B25J 9/1664; B25J 11/0085

(57) ABSTRACT

A robotic tank system may be used for performing functions related to a structure such as a tank or a hull structure, either which may be used for storage or ballast, comprises a robotic system comprising a base, a crane connected to the base, an end effector operatively connected to the crane, a control unit operatively in communication with the crane and the end effector, and a power unit operatively in communication with the crane, the end effector, and the control unit; a console operatively in communication with the control unit and with the power unit; and a tool selectively attached to the end effector, the tool operatively in communication with the control unit, the console, and the power unit.

### RELATION TO OTHER APPLICATIONS

This application claims priority through U.S. Provisional Application 62/583,614, filed Nov. 9, 2017.

### BACKGROUND

Performing functions such as cleaning and painting in large structures such as hulls and tanks used for offshore storage and/or ballast or structures where a confined space entrance exists and/or working at heights is often required. However, positioning human beings within the structure to perform these functions or having them work at heights or other non-easily accessible areas in such structures creates problems and often involves the need to work for long periods of time in confined spaces or working at heights.

### FIGURES

Various figures are included herein which illustrate aspects of embodiments of the disclosed inventions.

FIG. 1 is a view in partial perspective of an exemplary portable robotic system useful for tasks such as structure cleaning or painting;

FIG. 2 is a further view in partial perspective of an exemplary portable robotic system useful for tasks such as structure cleaning or painting;

FIG. 3 illustrates an exemplary console;

FIG. 4 illustrates an exemplary able robotic system being controlled by a human controller without a control console;

FIG. 5 illustrates an exemplary able robotic system being controlled by a human controller with a control console; and

FIG. 6 illustrates an exemplary able robotic system being used for a painting task.

### DESCRIPTION OF EXEMPLARY EMBODIMENTS

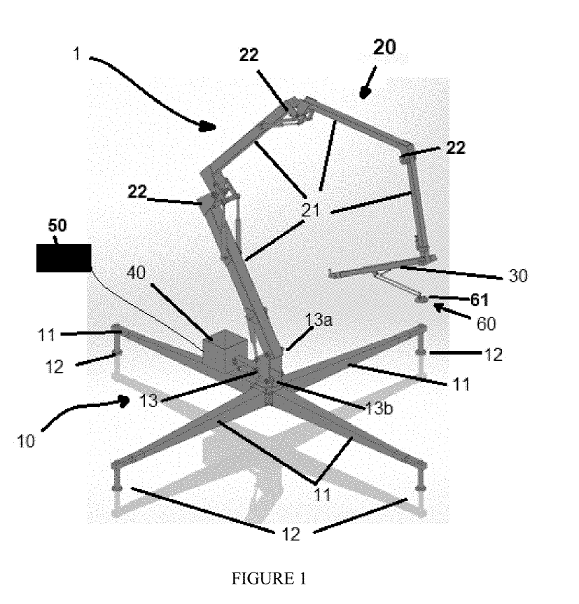

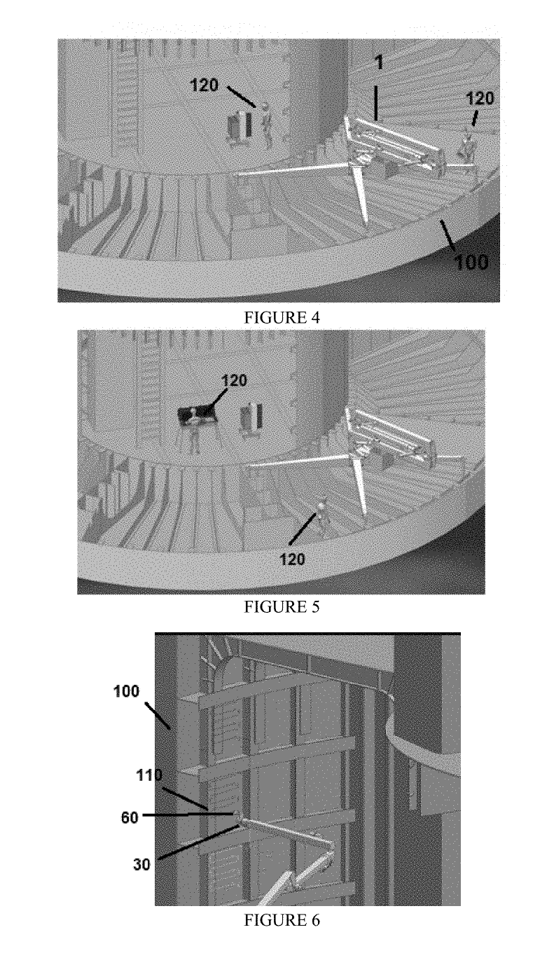

In a first embodiment, referring generally to FIG. 1, robotic system 1 is useful for performing functions related structure 100 (FIG. 4), which is typically used for storage or ballast, or the like such as a tank or a hull structure, and comprises base 10; crane 20 connected to base 10; one or more end effectors 30 operatively connected to 20 crane; one or more control units 40 operatively in communication with crane 20 and end effector 30; and one or power units 50 operatively in communication with crane 20, end effector 30, and control unit 40.

Base 10 may comprise a plurality of legs 11 where, in certain embodiments, each leg 11 comprises one or more feet 12.

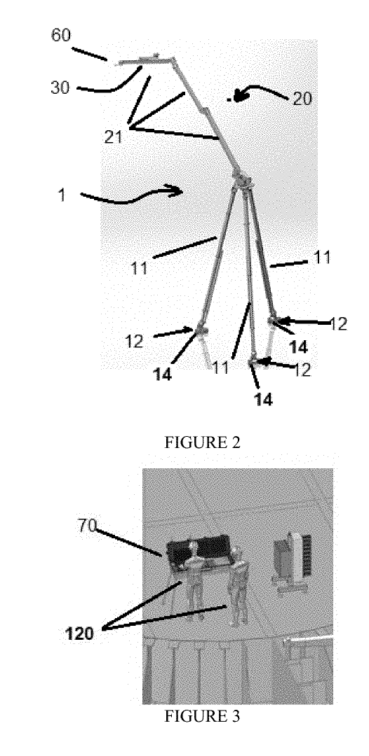

Referring additionally to FIG. 2, in embodiments, one or more legs 11 or the plurality of legs 11 and or more feet 12 are adjustable and, accordingly, may be adjusted to permit specific positioning around hazards and obstructions inside structure 100 (FIG. 4). By way of example and not limitation, in certain embodiments the plurality of legs 11 comprises a plurality of telescoping legs 11.

Tripod designs, as illustrated in FIG. 2, may also be used for smaller structures or for extended heights. Tripod designs will typically have the same design features as stated above.

In certain embodiments, one or more feet 12 comprise wheel 14 configured to fit on track 110 that is installed around an inside of structure 100 (FIG. 4). In other embodiments, wheels 13 may be used instead of feet 11. In either of these embodiments, wheels 14 may allow crane 20 to move and provide full access within structure 100, e.g. by allowing travel of robotic system 1 along track 110.

Referring back to FIG. 1, crane 20 may be pivotally connected to base 10 at first end 13a of hinge 13. In such embodiments, the plurality of legs 11 may be substantially rigidly connected to hinge 13.

One or more position sensors 22 may be disposed proximate crane 20 and operatively in communication with control unit 40.

Referring additionally to FIG. 2, in other of such embodiments, as illustrated in FIG. 2, one or more legs 11 the plurality of legs 11 may be flexibly connected to second end 13b of hinge 13.

In other embodiments, crane 20 comprises a plurality of interconnected, segmented crane arms 21. In certain of these embodiments, such as but not limited to where crane 20 comprises a plurality of interconnected, segmented crane arms 21, crane 20 may be foldable such that it can be inserted into a predetermined opening of structure 100. The opening, e.g. a man way, may comprise a width or diameter of around twenty four 24 inches. In any of these embodiments, a foldable crane 20 may be interested into the opening in its entirety or inserted into the opening in sections that can be re-integrated once inside structure 100.

Typically, control unit 40 operates one or more valves 41 (not shown in the figures) which can be used to control flow to power hydraulic cylinders and/or electrical drives (not shown in the figures) used to power or control power to power actuators on crane 20 to permit movement and operate the various tools 60.

Power unit 50 may comprise an A/C electrical power unit, a DC electrical power unit, a hydraulic power unit, or the like, or a combination thereof. Power unit 50 can be installed inside structure 100 on or off crane 20 or outside structure 100. Dedicated electrical and/or hydraulic lines can be fed to control unit 40 on crane 20.

In addition, tool 60 may be present and operatively attached to end effector 30, where tool 60 is also typically operatively in communication with control unit 40 and power unit 50 and operative to aid in performing functions related to structure 100. Tool 60 may be one or more of an inspecting tool, a cleaning tool, a conversion coating application tool, or a painting tool. In embodiments, the cleaning tool may comprise a high water pressure cleaning tool, a hyper water pressure cleaning tool, a media blasting cleaning tool, or a dry ice cleaning tool. In certain embodiments, tool 60 comprises a LIDAR tool. In addition, tool 60 can be used to apply various chemical cleaning solutions.

In embodiments, one or more video cameras 61 may be integrated into robotic system 1, in a manner, for example, similar to integration of tools 60 or otherwise attached or connected to legs 11 or end effectors 30.

Referring now to FIG. 3, robotic tank system 2 (not specifically called out in the figures) is useful for performing functions related to structure 100 comprises robotic system 1 (FIG. 1), which is as described above, and one or more consoles 70 operatively in communication with control unit 40 (FIG. 1) and with power unit 50 (FIG. 1). In addition, one or more tools 60 (FIG. 1) are present, as described above.

In embodiments, console 70 typically comprises a movement controller operatively in communication with, and adapted to send control directives to, control unit 40 (FIG. 1). If there are a plurality of control units, console 70 may be operatively in communication with, and adapted to send control directives to, each such control unit 40. Alternatively, separate consoles 70 may be present, each such console 70 operatively in communication with, and adapted to send control directives to, a specific subset of control units 40.

Power unit 50 (FIG. 1) and control unit 40 (FIG. 1) are controlled by console 70 and software. A control system, comprising console 70 and using position sensors 22 (FIG. 1) can enable crane 20 (FIG. 1) to extend, retract, move about to place tool 60 (FIG. 1) as need inside structure 100. Using cameras, lasers, lights, NDE sensors, and the like, to identify the position of tool 60 (and crane 20) with respect to structure 100, the control system can manipulate, arm, and move tool 60 in a path as required by the type of tool 60, e.g., to follow a crack identified by NDE sensors, zig-zag sweeping motions of the cleaning head (water jetting, brushes, and the like) by identifying unclean surfaces through use of video camera 61/or NDE sensors.

Crane 20 and tool 60 can also be operated manually at base 10 (FIG. 4) or remotely at console 70 (FIG. 5). Crane 20 and tool 60 may also be controlled in a supervised manner operating partially manually and autonomously.

In the operation of exemplary methods, referring back to FIG. 1, robotic system 1 and/or robotic tank system 2 which comprises robotic system 1, as described above, may be used to perform one or more predetermined functions related to structure 100, which is as also described above. Given its structure, in its embodiments robotic system 1 and/or robotic tank system 2 can access structures 100 such as a tanks and similar structures as large as or greater in size than 45′×45′×45′ in one setup, which may reduce a need to work in confined spaces, and/or reduce and/or eliminate need to work at heights.

Referring additionally to FIG. 6, robotic system 1 is typically located or maneuvered proximate an area of interest 110 of structure 100 and end effector 30 positioned proximate that area. Once so positioned, a predetermined function may be performed on area of interest 110 by using issuing a command to tool 60 to cause tool 60 to aid in performing the predetermined function on area of interest 110.

The predetermined function is typically an inspection function, a cleaning function, a conversion coating application function, a painting function, and/or screening an internal portion of structure 100 for conditions such as corrosion, wall thickness, crack detection, and other defects during or after cleaning. Tool 60 is selected as a specific to the predetermined function.

If screening performed, the screening may further comprise a non-destructive testing (NDE) inspection for functions such as crack depth, corrosion depth, and other defects after screening inspection.

CNC programming and/or learned/taught paths may be used to control movement of robotic system 1. In this manner, robotic system 1 may be able to move independently around hazards and move inside structure 100.

In embodiments, a teach pendant may be used with operator 120 inside structure 100 to control movement of robotic system 1. In such embodiments, console 70 may also be disposed inside structure 100.

In embodiments where one or more video cameras 61 (FIG. 1) are present, video camera 61 may be used to provide an image of area of interest 110 (FIG. 6) to a remotely located human being 120 and remotely located human being 120 allowed to watch the image remotely and to control movement of robotic system 1. If one or more video cameras 61 are present, video camera 61 may be used to supply an image to control unit 40 (FIG. 1) which can be used to process the image and use the processed image to identify and follow a shape of structure 100 (FIG. 6), to follow girders and braces, to detect and respond to other internal structures with and end of robotic system 1 (FIG. 1) such as tool 60 (FIG. 1), or the like, or a combination thereof. Video camera 61 may also be used provide an ability to provide general and detailed visual inspection such as corrosion during or after cleaning.

In embodiments where tool 60 (FIG. 1) comprises a LIDAR tool, the method further typically comprises using the LIDAR tool to develop a 3D mosaic view of an internal portion of structure 100 (FIG. 6) which is then used for coordination of controlling robotic system 1 (FIG. 1) using multi-axis (i.e., x,y,z) control commands.

Where robotic system 1 further comprises position sensor 22 (FIG. 1), position sensor 22 may be used to sense position of crane 20 (FIG. 1) and supply data representative of the sensed position to control unit 40 (FIG. 1) and/or console 70 (FIG. 3). The supplied data may then be used to allow control unit 40 to extend, retract, or move enable crane 20 to place tool 60 as needed inside structure 100.

The foregoing disclosure and description of the inventions are illustrative and explanatory. Various changes in the size, shape, and materials, as well as in the details of the illustrative construction and/or an illustrative method may be made without departing from the spirit of the invention.

1) A robotic system for performing functions related to a structure such as a tank used for storage or ballast or a hull structure, comprising:
a) a base;
b) a crane connected to the base;
c) an end effector operatively connected to the crane;
d) a control unit operatively in communication with the crane and the end effector; and
e) a power unit operatively in communication with the crane, the end effector, and the control unit.

2) The robotic system for performing functions related to structure such as a tank used for storage or ballast or a hull structure of claim 1, further comprising a tool operatively connected to the end effector, the tool operatively in communication with the control unit and the power unit and operative to aid in performing functions related to a tank used for storage or ballast or a hull structure.

3) The robotic system for performing functions related to structure such as a tank used for storage or ballast or a hull structure of claim 2, wherein the tool comprises an inspecting tool, a cleaning tool, a conversion coating application tool, or a painting tool.

4) The robotic system for performing functions related to structure such as a tank used for storage or ballast or a hull structure of claim 3, wherein the cleaning tool comprises a high water pressure cleaning tool, a hyper water pressure cleaning tool, a media blasting cleaning tool, or a dry ice cleaning tool.

5) A robotic tank system for performing functions related to a structure, comprising:
a) a robotic system, comprising:
i) a base;
ii) a crane connected to the base;
iii) an end effector operatively connected to the crane;
iv) a control unit operatively in communication with the crane and the end effector; and
v) a power unit operatively in communication with the crane, the end effector, and the control unit;
b) a console operatively in communication with the control unit and with the power unit; and
c) a tool selectively attached to the end effector, the tool operatively in communication with the control unit, the console, and the power unit, the tool operative to aid in performing functions related to the structure, the structure comprising a tank or a hull structure used for storage or ballast.

6) The robotic tank system for performing functions related to a structure of claim 5, wherein the console comprises a movement controller operatively in communication with, and adapted to send control directives to, the controller.

7) The robotic tank system for performing functions related to a structure of claim 5, wherein the base further comprises a plurality of legs, each leg comprising a foot.

8) The robotic tank system for performing functions related to a structure of claim 7, wherein the plurality of legs and the feet are adjustable.

9) The robotic tank system for performing functions related to a structure of claim 7, wherein the plurality of legs comprises a plurality of telescoping legs.

10) The robotic tank system for performing functions related to a structure of claim 7, wherein a foot of the feet comprises a wheel configured to fit on a track that is installed around an inside of a tank.

11) The robotic tank system for performing functions related to a structure of claim 7, the system further comprising a hinge, wherein:
a) the crane is pivotally connected to the base at a first end of the hinge; and
b) the plurality of legs are substantially rigidly connected to the hinge.

12) The robotic tank system for performing functions related to a structure of claim 7, the system further comprising a hinge, wherein:
a) the crane is pivotally connected to the base at a first end of the hinge; and
b) the plurality of legs are flexibly connected to a second end of the hinge.

13) The robotic tank system for performing functions related to a structure of claim 5, wherein the crane comprises a plurality of interconnected, segmented crane arms.

14) The robotic tank system for performing functions related to a structure of claim 5, wherein the crane is foldable such that it can be inserted into a predetermined opening of the structure.

15) The robotic tank system for performing functions related to a structure of claim 14, wherein the opening comprises a diameter of around twenty four (24) inches.

16) The robotic tank system for performing functions related to a structure of claim 14, wherein the foldable crane can be interested into the predetermined opening of the structure in its entirety.

17) The robotic tank system for performing functions related to a structure of claim 14, wherein the foldable crane can be interested into the predetermined opening of the structure by sections that can be re-integrated once inside the structure.

18) The robotic tank system for performing functions related to a structure of claim 5, wherein the power unit comprises an electrical power unit or a hydraulic power unit.

19) A method of using a robotic tank system for performing functions related to structure, the robotic tank system comprising a robotic system comprising a base, a crane connected to the base, an end effector operatively connected to the crane, a control unit operatively in communication with the crane and the end effector, and a power unit operatively in communication with the crane, the end effector, and the control unit; a console operatively in communication with the control unit and with the power unit; and a tool selectively attached to the end effector, the tool operatively in communication with the control unit, the console, and the power unit, the method comprising:
a) positioning the robotic system proximate an area of the structure;
b) positioning the end effector proximate the area of the structure; and
c) performing a predetermined function on the area of the structure by using issuing a command to the tool to cause the tool to aid in performing the predetermined function on the area of the structure.

20) The method of using a robotic tank system for performing functions related to a structure of claim 19, wherein:
a) the predetermined function comprises an inspection function, a cleaning function, a conversion coating application function, or a painting function; and
b) the tool is a specific tool for the predetermined function.

21) The method of using a robotic tank system for performing functions related to a structure of claim 19, further comprising:
a) integrating a video camera into the robotic system;
b) using the video camera to provide an image to a remotely located human being;
c) allowing the remotely located human being to watch the image remotely; and
d) allowing the human operator to control movement of the robotic system.

22) The method of using a robotic tank system for performing functions related to a structure of claim 21, further comprising:
a) using the video camera to supply an image to the controller;
b) using the controller to process the image; and
c) using the processed image used to identify and follow a shape of the tank, to follow girders and braces, or to detect and respond to other internal structures with the robot tip.

23) The method of using a robotic tank system for performing functions related to a structure of claim 19 wherein the tool comprises a LIDAR tool, the method further comprising:
a) using the LIDAR tool to develop a 3D mosaic view of an internal portion of the tank; and
b) using the 3D mosaic view of an internal portion of the tank for coordination of the robotic control using x,y,z control commands.

24) The method of using a robotic tank system for performing functions related to a structure of claim 25, further comprising using the robotic device to screen the internal portion of the structure for conditions such as corrosion, wall thickness, crack detection, and other defects during or after cleaning.

25) The method of using a robotic tank system for performing functions related to a structure of claim 26, wherein the screening further comprises NDE inspection for functions such as crack depth, corrosion depth, and other defects after screening inspection.

26) The method of using a robotic tank system for performing functions related to a structure of claim 19 where the robotic system further comprises a position sensor disposed proximate the crane and operatively in communication with the controller, the method further comprising:
a) supplying data from the position sensor to the control system; and
b) using supplied data to allow the control system to extend, retract, or move enable the crane to place the tool as needed inside the tank.
